(19) United States
(12) Patent Application Publication
(10) Pub. No.: US 2006/0191206 A1
(43) Pub. Date: Aug. 31, 2006

(54) Exterior equipment module

(76) Inventors: Robert Brady Mooney, Farmington Hills, MI (US); Robert Boyer Dickie, Canton, MI (US); David Lawrence Newkirk, Sterling, MI (US)

Correspondence Address: CLARK HILL, P.C., 500 WOODWARD AVENUE, SUITE 3500, DETROIT, MI, 48226, US

(21) Appl. No.: 11/364,282

(22) Filed: Feb. 28, 2006

Related U.S. Application Data
(60) Provisional application No. 60/657,478, filed on Feb. 28, 2005.

(51) Int. Cl. B60J 5/04

(52) U.S. Cl. 49/502

(57) ABSTRACT

A door assembly for a motor vehicle includes an interior panel defining a compartment and an exterior panel secured to the interior panel and having an aperture providing access to the compartment. An equipment module is sized to enter the compartment via the aperture. The equipment module includes a carrier plate adapted to abut against a portion of the exterior panel surrounding the aperture. The door assembly also includes at least one accessory mounted to the carrier plate. The carrier plate is retained on all sides by the exterior panel.

### CROSS-REFERENCE TO RELATED APPLICATION

This application claims priority to and all the benefits of U.S. Provisional Application No. 60/657,478, filed on Feb. 28, 2005 and entitled “Exterior Equipment Module.”

### FIELD OF THE INVENTION

The invention relates to motor vehicle door assemblies. More particularly, the invention relates to an equipment module that carries at least one accessory for a door assembly of a motor vehicle.

### BACKGROUND OF THE INVENTION

A rear liftgate or tailgate of a motor vehicle generally includes a number of accessory components. Such components include, but are not limited to, brake lights, turn signals, a windshield wiper motor, a license plate bucket and a latch assembly. Historically, each of these components has been shipped to the factory and individually assembled onto the door. This process of mounting each component separately required a high level of inventory tracking and increased the assembly time of the door. Additionally, it was difficult to test individual electrical and electronic components until after they were mounted and connected to the wiring harness and electronic control module (ECM).

More recently, efforts have been made to simplify the process of assembling a rear door and its accessory components. For example, DE patent 197 13 317 to Ymos et al. teaches a tailgate including a light alloy frame, made of pressed or rolled L-shaped rails, connected by an upper traverse. A second traverse, located between the two rails, holds a rear window inner and outer cover. The frame can be cast with joints for hinges and molded space to accommodate rear lights and indicators. An exterior panel having a license plate bucket is attached to a lower portion of the frame, and a windshield wiper arm and motor are attached to the upper traverse.

U.S. Pat. No. 6,053,562 to Bednarski teaches a rear door assembly including a singular tubular frame having side members that terminate in laterally extending and opposing foot portions. At least one exterior panel is connected to the tubular frame. A cross member connects and reinforces two parallel portions of the tubular frame. A plurality of accessories, such as a windshield wiper motor or a break light are mounted on the cross member. Outer and interior panels are then mounted to the tubular frame adjacent the cross member.

Another way to simplify rear door assembly is to make use of carrier modules that are preloaded with the desired accessories. For example, U.S. Pat. No. 6,019,418 to Emerling et al. discloses a structural liftgate module including a structural plate and a trim plate that is mounted to the interior-facing side of the liftgate sheet metal. A liftgate lock and latch assembly, wiring harness, brake light, and rear windshield wiper motor are all mounted to the trim plate module. The brake light extends beyond the trim plate so that it is visible through the rear window of the liftgate when mounted. The trim plate is attached to the structural plate prior to mounting the assembled structure module to the liftgate.

U.S. Pat. No. 6,123,384 to Eustache et al. teaches a mounting plate for a vehicle tailgate that is mounted to an interior-facing surface of a rear door. A windshield wiper motor and a control module are pre-loaded onto the mounting plate. When the mounting plate is attached to the rear door, the output shaft on the windshield wiper motor extends through an aperture in the rear door to the outside of the vehicle. A windshield wiper arm can subsequently be mounted to the output shaft. In addition, an electric latch for the rear door window is provided at one end of the mounting plate. The electric latch provides the means to secure a flip glass window in the rear door.

U.S. Pat. No. 6,174,016 to Ponziani teaches a single module that includes a plurality of integrally molded features and accessories which are mounted to an interior sheet metal surface of the rear door. Accessories include windshield wiper motor, electrical door latches, rear door handle, stoplight, and a license plate illumination system. Accessories intended to be visible from the exterior of the vehicle (i.e., handle and license plate illumination system) align with apertures in the rear door. The module includes preformed support regions to assist in mounting the components to the module as well as integral clips to retain a wiring harness. In addition, the module includes at least one molded handling area to assist a worker in aligning and mounting the module to the door. A trim component is then mounted over the module to hide it from view of the interior of the vehicle.

U.S. Pat. No. 6,776,449 to Komatsu et al. discloses a rear door including an exterior panel, a frame-shaped interior panel and a module plate to which door parts such as a windshield wiper motor are attached. The module plate extends substantially across the entire rear door between two parallel side portions of the interior panel, reinforcing the rear door. Preferably, the module plate is spot-welded into place.

U.S. patent application Ser. No. 10/275,644 to Simon et al. teaches an equipment module that is mounted to an interior facing side of a liftgate sheet metal. One side of the module holds a plurality of liftgate accessories, such as a windshield wiper motor and a brake light. The other side of the module is adapted to provide a trim that faces the interior of the vehicle. Thus, no additional trim components are required for the interior of the rear door. In addition, other accessories such as a cargo area light can be exposed to the interior of the vehicle via apertures in the equipment module.

While all of the above equipment modules simplify the construction of the rear hatch, they are not without their limitations. Each one is mounted either to a partially-assembled door, or to the interior-facing side of the door. In contrast, U.S. Pat. No. 6,637,801 to Eustace et al. discloses a module that is mounted to an exterior-facing side of the rear door. The module contains a plurality of accessories, such as a windshield wiper motor and arm, license plate bucket, brake light, and flip glass latch. The module is received in a housing located on an upper edge of a door panel adjacent the door's window glass aperture. While the exterior-mounted equipment module is more easily mounted than modules mounted from the interior side of the door, the module is not without its own drawbacks. One drawback is that the module is relatively small and contains a limited number of accessories. Another drawback is that the module is somewhat prone to being wrenched out of its housing, due to a lack of a solid door frame encapsulating its upper edge beside the window glass. Supplemental support beans are used to secure the equipment module to the door.

It is, therefore, desirable to produce an equipment module for a rear door that can mount multiple accessories prior to mounting the module to the door. It is further desirable to produce a module that can be mounted to an exterior-facing surface of the rear door. It is also desirable to produce an outside module that includes an aesthetic trim for the exterior of the vehicle. It is also desirable to produce an equipment module that is completely surrounded by the exterior panel in order to resist wrenching.

### SUMMARY OF THE INVENTION

According to a first aspect of the invention, a door assembly for a motor vehicle includes an interior panel having a compartment and an exterior panel secured to the interior panel and having an outer module aperture providing access to the compartment. An equipment module is sized to enter the compartment via the aperture. The equipment module includes a carrier plate adapted to abut against a portion of the exterior panel surrounding the aperture. At least one accessory is mounted to the carrier plate. The carrier plate is retained on at least one side by the exterior panel.

According to another aspect of the invention, an equipment module is provided for a motor vehicle door assembly having an interior panel defining a compartment and an exterior panel defining an outer module aperture. The equipment module includes a carrier plate sized to enter the compartment through the aperture. The carrier plate includes an outer peripheral edge adapted to abut against a portion of the exterior panel surrounding the outer module aperture. The equipment module also includes at least one accessory mounted to the carrier plate. The outer peripheral edge of the carrier plate is retained on at least one side by the exterior panel.

According to yet another aspect of the invention, a method is provided for installing an equipment module, having a carrier plate and at least one accessory mounted thereto, to a motor vehicle door assembly including an interior panel defining a compartment and an exterior panel having an outer module aperture. The method includes the step of: mounting the at least one accessory to the carrier plate to form the equipment module; inserting the equipment module into the outer module aperture of the exterior panel; positioning the carrier plate partially within the compartment such that the carrier plate is retained in place by a portion of the exterior panel surrounding the outer module aperture; and securing the equipment module to the interior panel.

### DETAILED DESCRIPTION OF THE DRAWINGS

The present invention will be readily appreciated as the same becomes better understood by reference to the following detailed description when considered in connection with the accompanying drawings wherein:

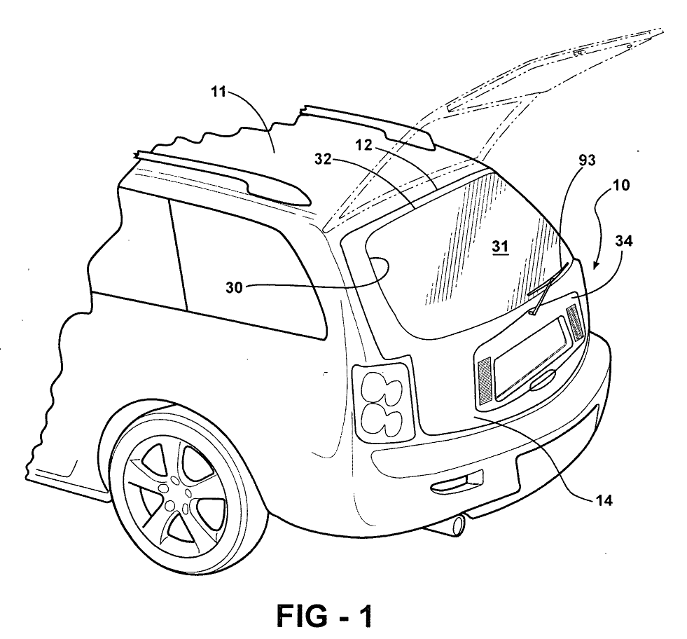

FIG. 1 is a fragmentary, perspective view of a motor vehicle including an equipment module mounted along a rear liftgate;

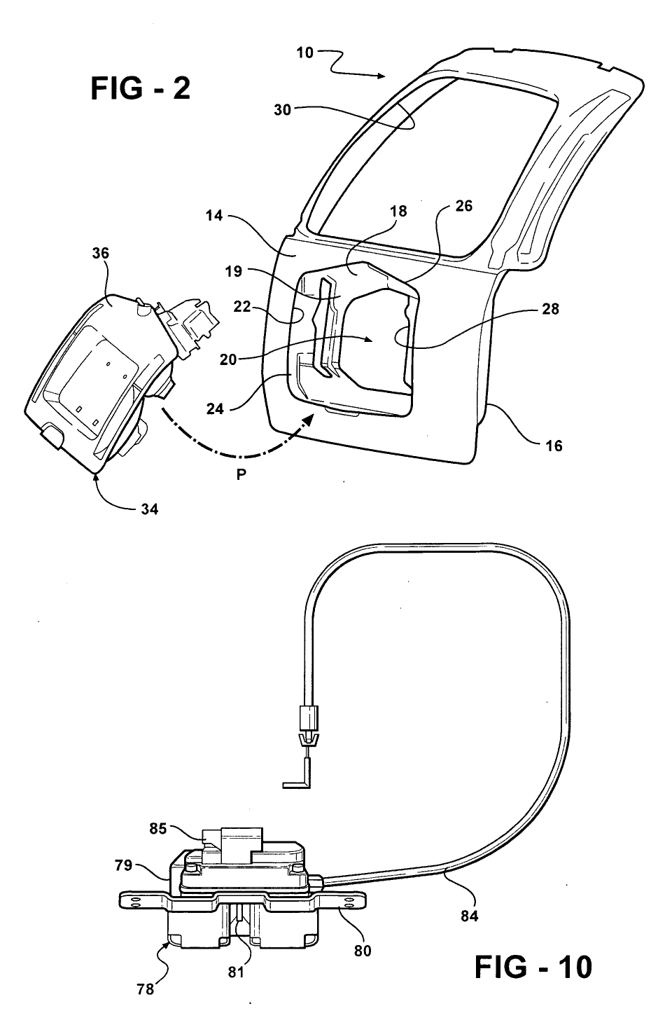

FIG. 2 is an exploded, perspective view of the rear liftgate;

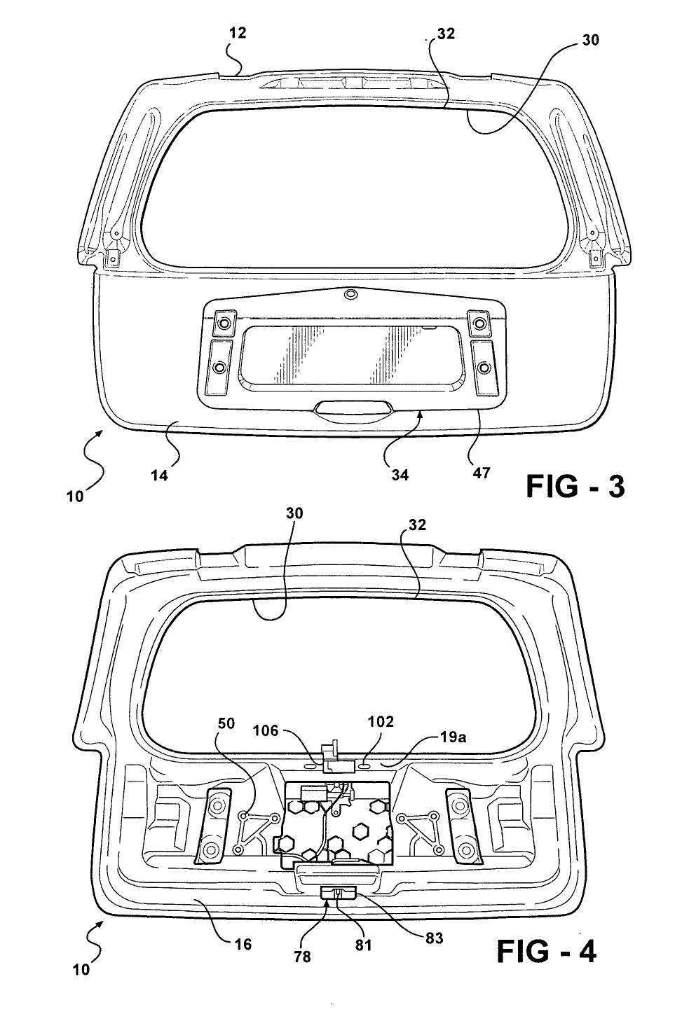

FIG. 3 is a exterior plan view of the rear liftgate including the equipment module;

FIG. 4 is an interior plan view of the rear liftgate including the equipment module;

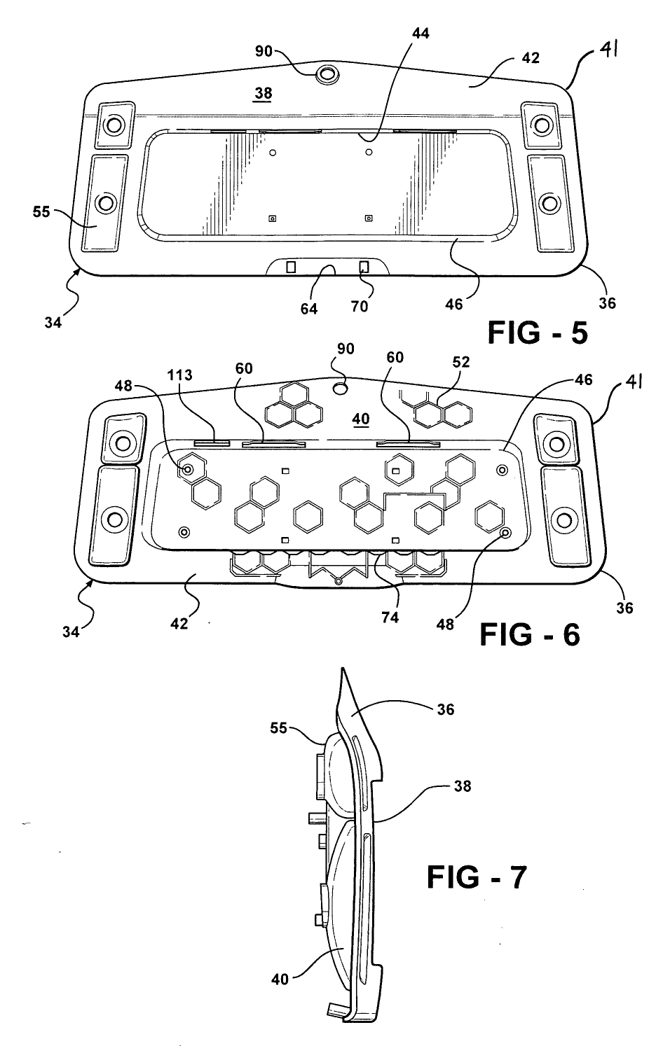

FIG. 5 is a plan view of an outer surface of a carrier plate of the equipment module;

FIG. 6 is a plan view of an inner surface of the carrier plate of the equipment module;

FIG. 7 is a perspective view of the carrier plate of the equipment module;

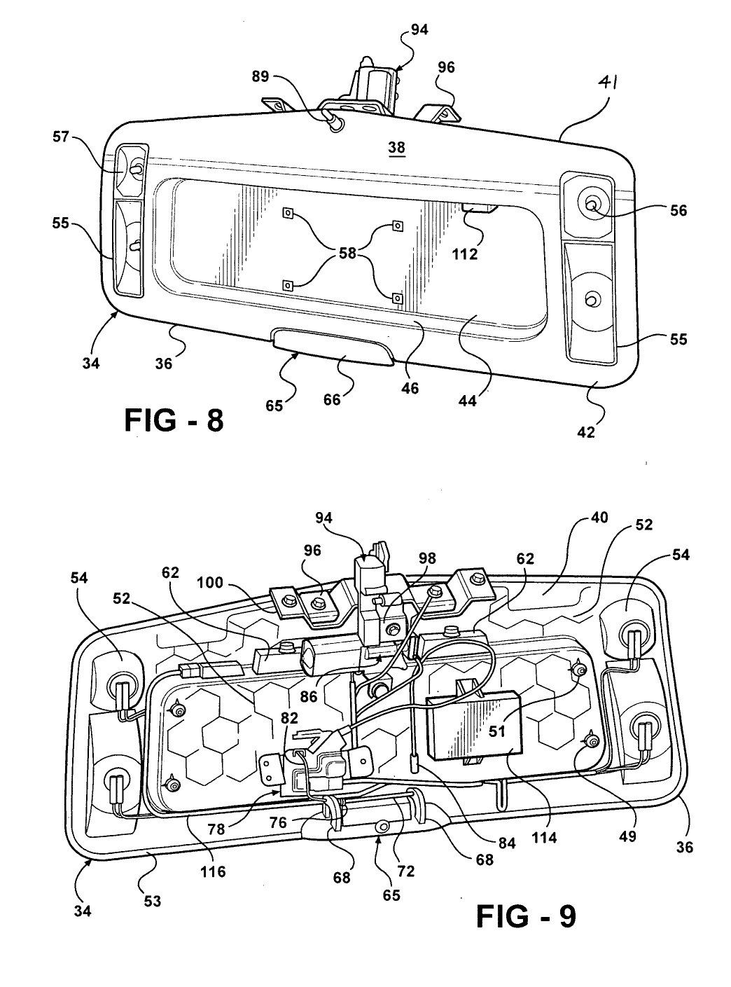

FIG. 8 is an outer perspective view of the equipment module including a plurality of accessories mounted to the carrier plate;

FIG. 9 is an inner perspective view of the equipment module including the plurality of accessories mounted to the carrier plate;

FIG. 10 is a perspective view of a latch assembly;

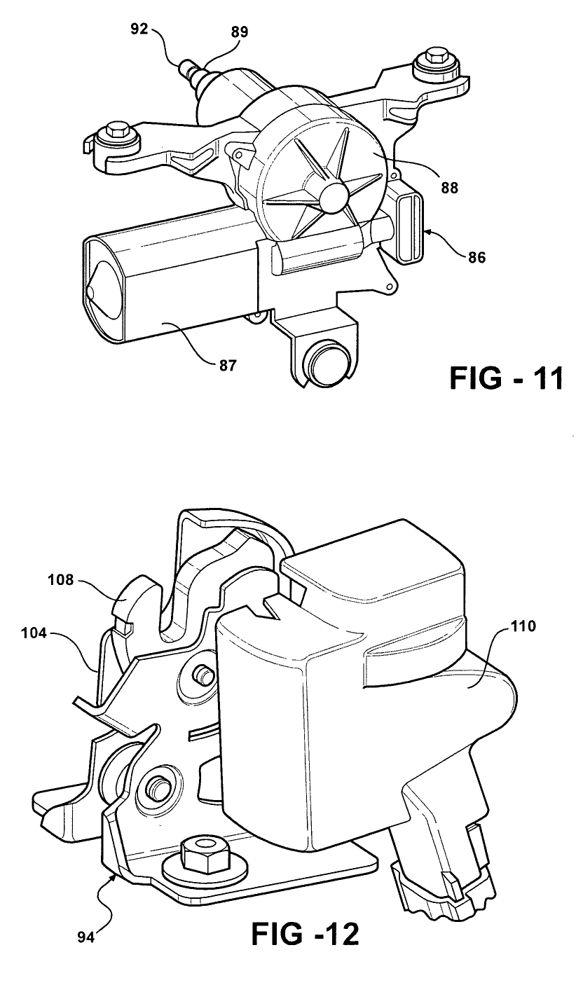

FIG. 11 is a perspective view of a windshield wiper motor assembly of the equipment module; and

FIG. 12 is a perspective view of a flip glass latch assembly of the equipment module.

### DETAILED DESCRIPTION OF THE INVENTION

Referring to FIG. 1, a door assembly, generally shown at 10, is mounted to a motor vehicle 11. The door assembly 10 is pivotally movable between a closed position, shown in solid line, and an open position, shown in dashed line, to provide selective access to an interior cargo area (not shown.) In the illustrated embodiment, the door assembly 10 is a rear liftgate that pivots along a horizontal axis about an upper edge 12. It is, however, contemplated that the door assembly 10 may be any of various closure panels including, but not limited to, a tailgate or a liftgate and tailgate combination. Alternatively, the door assembly 10 could pivot along a vertical axis about an upright edge as in a conventional side door. Preferably, a pair of struts (not shown) extends between the rear liftgate 10 and a body portion of the motor vehicle 11 to assist in movement of the rear liftgate 10 between the closed position and the open position.

Referring to FIGS. 2 through 4, the rear liftgate 10 is assembled by mounting an exterior panel 14 to an interior panel 16. More specifically, the edges of the exterior panel 14 and the interior panel 16 are welded together to manufacture the rear liftgate 10. The exterior panel 14 is visible from outside the motor vehicle 11 while the interior panel 16 is visible from the interior cargo area. The exterior panel 14 provides a smooth and aerodynamic surface on the motor vehicle exterior while the interior panel 16 generally provides a structural frame. Typically, the exterior 14 and interior 16 panels are manufactured by forming and blanking sheet metal.

The interior panel 16 includes an outboard wall 18 that is spaced apart from the exterior panel 14 by a web portion 19. A compartment 20 extends through the outboard wall 18 and the web portion 19. The exterior panel 14 includes an outer module aperture 22 for providing access to the compartment 20 from outside the motor vehicle 11. A lip 24 is formed along the outboard wall 18 of the interior panel 16 and extends between the web portion 19 and an edge 26 extending around the outer module aperture 22. In addition, an inner module aperture 28 is provided in the outboard wall 18 to provide access to the compartment 20 from the interior cargo area.

A window glass aperture 30 extends through both the exterior 14 and interior 16 panels of the rear liftgate 10. A window glass 31 is typically mounted to the rear liftgate 10 for selectively closing the window glass aperture 30. In the present embodiment, the window glass 31 is a “flip glass” that pivots between an open position and a closed position along a horizontal axis about an upper edge 32 bordering the window glass aperture 30. The flip glass provides access to the interior cargo area without the need for moving the rear liftgate 10 from the closed position to the open position. Alternatively, the window glass 31 can be permanently mounted in place over the window glass aperture 30.

A pre-assembled equipment module, generally indicated at 34, is mounted to the rear liftgate 10 and carries a plurality of accessories on a carrier plate 36. The carrier plate 36 is typically manufactured from a durable polycarbonate and acrylonitrile-butadiene-styrene (PC ABS) resin. PC ABS resins are durable even at a low temperature and can be manufactured in a wide range of colors and shapes via injection molding. It is, however, appreciated that the carrier plate 36 may be formed from any of numerous materials and methods of manufacture as known to those skilled in the art.

Referring to FIGS. 5 through 7, the carrier plate 36 includes an outer surface 38 that is visible from outside the motor vehicle 11. The outer surface 38 has a profile that is complementary to a portion of the exterior panel 14 and may be painted to match the color of the exterior panel 14. The carrier plate 36 also includes an opposing inner surface 40. The inner surface 40 faces the interior cargo area when the rear liftgate 10 is in the closed position.

The carrier plate 36 is substantially the same size and shape as the outer module aperture 22 and includes an outer peripheral edge 41. The carrier plate 36 includes a peripheral flange region 42 surrounding a recessed central region 44 and connected thereto by a web portion 46. When positioned within the outer module aperture 22, the flange region 42 abuts against the lip 24 and the central region 44 extends into the compartment 20. Preferably, the flange region 42 is engineered to provide the same thickness and aerodynamic contours as the adjacent areas of the exterior panel 14 so that the flange region 42 and exterior panel 14 provide a smooth surface with only a small seam 47 between them, as shown in FIG. 3. Portions of the inner surface 40 are exposed to the compartment 20.

A plurality of reinforced mounting sockets 48 extends out from inner surface 40 of the carrier plate 36 for receiving respective fasteners 49, shown in FIG. 9. The fasteners 49 may be bolts, screws, rivets, or the like. When the carrier plate 36 is disposed within the outer module aperture 22, the mounting sockets 48 align with respective mounting apertures 50, shown in FIG. 4, formed in the interior panel 16. The fasteners 49 are mounted in the respective mounting sockets 48 and extend fully through the mounting apertures 50 past the interior panel 16. Locking nuts 51, shown in FIG. 9, are placed over the fasteners 49 to abut against the opposing side of the interior panel 16 and retain the carrier plate 36 securely in place within the outer module aperture 22.

Referring to FIGS. 8 and 9, a plurality of reinforcement ribs 52 extends across the inner surface 40 of the carrier plate 36 in order to increase the rigidity of the equipment module 34. A waterproof seal 53 extends around the inner surface 40 of the carrier plate 36. The seal 53 abuts against the interior panel 16 through the seam 47. Trim components, which have been omitted from the drawings for the purpose of clarity, are typically mounted to the inner surface 40 of the interior panel 16 to hide both the interior panel 16 and the carrier plate 36.

A plurality of accessories can be mounted to the equipment module 34 prior to installation along the rear liftgate 10. A pair of spaced apart light assemblies 54, each having a casing 55, a bulb 56 and a protective lens 57, can be mounted to the carrier plate 36. The pair of light assemblies 54 is able to provide multiple lighting functions, including but not limited to, backup/reverse lights, running lights and turning signals.

The central region 44 includes a plurality of license mounting holes 58 to locate and fasten a license plate (not shown) to the outer surface 38 of the carrier plate 36. In addition, a pair of license plate lighting apertures 60, shown in FIG. 6, is located in the web portion 46. A license plate lighting assembly 62 is mounted to the inner surface 40 of the carrier plate 36 over each license plate lighting aperture 60 to illuminate the central region 44 in low lighting conditions or at night.

Referring again to FIGS. 8 and 9, a handle assembly, generally indicated at 65, is mounted to the equipment module 34. A handle recess 64 is formed along an outer edge of the carrier plate 36 to provide a convenient hand space for a user. A liftgate handle 66 is pivotally mounted to the outer surface 38 of the carrier plate 36 adjacent the handle recess 64 for movement between a rest position and an actuated position. A pair of handle arms 68 extends out from opposing ends of the handle 66 through a pair of handle apertures 70 of the carrier plate 36 and into the compartment 20. A handle pin 72 extends between the pair of handle arms 68 and is retained within at least one bracket 74 extending out from the inner surface 40. A handle spring 76 is coiled around a handle pin 72 for biasing the handle 66 towards the rest position. The handle spring 76 is attached to one of the handle arms 68 and to one of the brackets 74.

A latch assembly, generally indicated at 78, is mounted to the inner surface 40 of the carrier plate 36 and is operable to be actuated by the handle assembly 65. The latch assembly 78 includes a lock/unlock function to decouple the latch assembly 78 from the handle assembly 65. Referring to FIG. 10, a latch bracket 79 is provided for mounting the latch assembly 78 to the carrier plate 36 at an angle substantially perpendicular to the inner surface 40. The latch assembly 78 also includes a door bracket 80 that is operable to secure the latch assembly 78 to the interior panel 16 via fasteners in order to provide additional reinforcement. The latch assembly 78 includes a ratchet 81 extending through an aperture 83 in the interior panel 16. The ratchet 81 is operable to engage and release a striker (not shown) mounted to a portion of the motor vehicle 11 adjacent the rear liftgate 10 when the rear liftgate 10 is in the closed position. Preferably, the latch assembly 78 also includes an actuator 85 to provide power release functionality for the rear liftgate 10. The latch assembly 78 also includes a manual release function. A handle release lever 82 extends out from one of the handle arms 68 and is connected to a cable 84, which in turn is connected to the latch assembly 78. Thus, actuating the handle 66 when the latch assembly 78 is unlocked releases the ratchet 81.

A windshield wiper motor assembly, generally indicated at 86, is mounted to the inner surface 40 of the carrier plate 36. Referring to FIG. 1, the windshield wiper motor assembly 86 includes an electric motor 87, a gear reducer 88, and an output shaft 89. The output shaft 89 extends through a wiper aperture 90 in the carrier plate 36, as shown in FIG. 6, to the exterior of the motor vehicle 11 at an angle substantially perpendicular to the window glass 31. A wiper blade arm 93 is operably coupled to one end 92 of the output shaft 89 for rotation in an arc relative to the window glass 31. When not in motion, the wiper blade arm 93 rests at a position below the window glass aperture 30, thus not blocking visibility through the window glass 31 or interfering with the flip glass.

Referring back to FIG. 9, the equipment module 34 further includes a flip glass latch assembly 94 that is secured to the rear liftgate 10 by a flip glass bracket 96. The flip glass bracket 96 is mounted to a projection 98 extending out from the windshield wiper motor assembly 86. A pair of mounting flanges 100 extends out on opposing sides of the flip glass bracket 96 and abuts against the web portion 19 on the interior panel 16. Complementary apertures 102 in both the mounting flanges 100 and the web portion 19 allow the flip glass bracket 96 to be securely fastened to the interior panel 16. A latch casing 104, shown in FIG. 12, is secured to the flip glass bracket 96 and projects through a latch aperture 106 in the web portion 19. A flip glass ratchet 108 is rotatably mounted in the latch casing 104 and is operable to receive a striker (not shown) mounted to and extending from the window glass 31 when the window glass 31 is closed. The flip glass latch assembly 94 also includes a flip glass actuator 110 operable to engage or release the flip glass ratchet 108. A release button 112 extends out through an aperture 113 in the web portion 46 to the outer surface 38 of the carrier plate 36. Pressing the release button 112 while the motor vehicle 11 is unlocked causes the flip glass actuator 110 to release the flip glass ratchet 108 and allows the window glass 31 to open.

Referring once again to FIG. 9, an electric control module (ECM) 114 is mounted to the inner surface 40 of the carrier plate 36. The ECM 114 provides the control and diagnostic functions of the electrical light, lock, and wiper systems of the equipment module 34. For example, the ECM 114 disables the latch assembly 78 and the flip glass latch assembly 94 when the motor vehicle 11 is locked. A wiring harness 116 connects the ECM 114, the light assemblies 54, the windshield wiper motor assembly 86, the latch assembly 78, and the flip glass latch assembly 94. If desired, the inner surface 40 of the carrier plate 36 can include protruding harness clips or cable conduits.

While the above-described accessories are typical equipment to be mounted to the equipment module 34, it will be recognized that other accessories can also be added. For example, a decorative brand insignia can be added to the outer surface 38 of the carrier plate 36. A Center High Mounted Stop Lamp (CHMSL) can be attached to an upper end of the flip glass latch assembly 94, or alternatively, mounted within a centered lighting aperture of the carrier plate 36 directly. An interior cargo light may be mounted on the inner surface 40 of the carrier plate 36. Another possible accessory is a key cylinder that could be attached to either of the latch assembly 78 or the flip glass latch assembly 94. Yet another possible accessory is a rear vision system for detecting obstacles behind the motor vehicle during reverse operation. Yet another possible accessory would be a brand identification logo from the vehicle manufacturer mounted to the outer surface 38 of the carrier plate 36. Other accessories suitable for the equipment module 34 will occur to those of skill in the art and are within the scope of the invention.

Preferably, the above-described accessories, including the pair of light assemblies 54, the handle assembly 65, the latch assembly 78, the windshield wiper motor assembly 86, and the flip glass latch assembly 94, are mounted to one of the outer 38 and inner 40 surfaces of the carrier plate 36 and tested prior to mounting the equipment module 34 to the rear liftgate 10. To install the equipment module 34 to the rear door 10, the pre-assembled equipment module 34 is inserted into the compartment 20 along motion path ‘P’ shown in FIG. 2. The flip glass latch assembly 94 passes through the latch aperture 106 and clears the interior panel 16. The edges of the outer module aperture 22 assist in aligning the carrier plate 36 into position against the lip 24 of the interior panel 16. The pre-loaded fasteners 49 pass though the mounting apertures 50 and are secured in place with the nuts 51. The latch assembly 78 and the flip glass assembly 94 are also fastened to the interior panel 16. The ECM 114 is subsequently connected to the motor vehicle's power supply (not shown). The pre-assembly, testing, and installation of the equipment module 34 simplify the process of manufacturing the rear liftgate 10. Since the edge 26 of the carrier plate 36 is completely surrounded by the exterior panel 14, the equipment module 34 is securely attached to the rear liftgate 10.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

What is claimed:

1. A door assembly for a motor vehicle, said door assembly comprising:
an interior panel defining a compartment;
an exterior panel secured to said interior panel and having an aperture providing access to said compartment;
an equipment module sized to enter said compartment via said aperture, said equipment module including a carrier plate adapted to abut against a portion of said exterior panel surrounding said aperture; and
at least one accessory mounted to said carrier plate;
wherein said carrier plate is retained on at least one side by said exterior panel.

2. A door assembly as set forth in claim 1 wherein said interior panel includes a lip for receiving a portion of said carrier plate thereagainst.

3. A door assembly as set forth in claim 1 wherein said carrier plate is mounted to said interior panel via fasteners.

4. A door assembly as set forth in claim 3 wherein said carrier plate includes a plurality of mounting sockets for receiving said fasteners in order to secure said carrier plate to said interior panel.

5. A door assembly as set forth in claim 4 wherein said interior panel includes a plurality of mounting apertures extending therethrough for receiving said fasteners to secure said equipment module to said door assembly.

6. A door assembly as set forth in claim 1 wherein said interior panel includes an outboard wall facing the exterior panel for receiving said carrier plate thereagainst in order to facilitate installation of said equipment module to said door assembly.

7. A door assembly as set forth in claim 1 wherein said carrier plate includes an outer peripheral edge retained in place by a portion of said exterior panel.

8. A door assembly as set forth in claim 1 wherein said at least one accessory includes at least one latch assembly mounted to said carrier plate and accessible through said inner module aperture in said interior panel and operable to prevent release of said door assembly.

9. A door assembly as set forth in claim 8 wherein said latch assembly is mounted to said interior panel.

10. A door assembly as set forth in claim 8 wherein said at least one accessory includes a handle pivotally mounted to said carrier plate and operable to actuate said latch assembly.

11. A door assembly as set forth in claim 1 wherein said at least one accessory includes a lighting assembly mounted to said carrier plate and visible from outside the vehicle via an aperture in said carrier plate.

12. A door assembly as set forth in claim 1 wherein said door assembly defines a window aperture for receiving a window glass.

13. A door assembly as set forth in claim 12 wherein said at least one accessory includes a flip glass latch assembly mounted to said carrier plate and operably connected to said window glass.

14. A door assembly as set forth in claim 13 including a switch mounted to said carrier plate for actuating said flip glass latch assembly.

15. A door assembly as set forth in claim 14 including a plurality of license mounting holes formed along said carrier plate.

16. A door assembly as set forth in claim 1 wherein said at least one accessory includes a license plate lighting assembly mounted to said carrier plate and visible from outside the motor vehicle via an aperture in said carrier plate for illuminating a portion of said carrier plate.

17. A door assembly as set forth in claim 1 wherein said at least one accessory includes a windshield wiper motor mounted to said carrier plate.

18. A door assembly as set forth in claim 17 including an output shaft driven by said windshield wiper motor and connected to a windshield wiper arm.

19. A door assembly as set forth in claim 1 including an electronic control module mounted to said carrier plate for controlling the functions of said at least one accessory.

20. An equipment module for a motor vehicle door assembly having an interior panel defining a compartment and an exterior panel defining an outer module aperture, said equipment module comprising:
a carrier plate sized to enter the compartment via the aperture, said carrier plate having an outer peripheral edge adapted to abut against a portion of the exterior panel surrounding the outer module aperture; and
at least one accessory mounted to said carrier plate;
wherein said outer peripheral edge of said carrier plate is retained on at least one side by the exterior panel.

21. A method for installing an equipment module, including a carrier plate having at least one accessory secured thereto, to a motor vehicle door assembly including an interior panel defining a compartment and an exterior panel defining an outer module aperture, the method comprising the steps of:
mounting the at least one accessory to the carrier plate to form the equipment module;
inserting the equipment module into the outer module aperture of the exterior panel;
positioning the carrier plate partially within the compartment such that the carrier plate is retained in place by a portion of the exterior panel surrounding the outer module aperture; and
securing the equipment module to the interior panel.

22. A method as set forth in claim 21 wherein the step of mounting the at least one accessory to the carrier plate to form the equipment module occurs prior to the step of inserting the equipment module into the outer module aperture in the exterior panel.
